(19) United States
(12) Patent Application Publication
(10) Pub. No.: US 2024/0271965 A1
(43) Pub. Date: Aug. 15, 2024

(54) SENSING ASSEMBLY FOR DICHOTOMIC SENSING

(71) Applicant: KSR IP Holdings, LLC, Wilmington, DE (US)

(72) Inventors: Jaesung Kim, Ridgetown (CA); Martin Parks, Bothwell (CA); Addison Copeland, Dresden (CA)

(73) Assignee: KSR IP Holdings, LLC, Wilmington, DE (US)

(21) Appl. No.: 18/441,244

(22) Filed: Feb. 14, 2024

Related U.S. Application Data
(60) Provisional application No. 63/445,486, filed on Feb. 14, 2023.

(51) Int. Cl. G01D 5/20; G01D 5/14

(52) U.S. Cl. CPC G01D 5/20; G01D 5/145

(57) ABSTRACT

Embodiments herein are directed to a position sensor. The position sensor includes an inductive sensor assembly, a secondary sensor, and a coupler member. The inductive sensor assembly includes a transmitter coil and at least one receiver coil located proximate to the transmitter coil. The at least one receiver coil generating a receiver signal when the transmitter coil is excited. The receiver signal being sensitive to a position of a part. The secondary sensor is positioned within an inner diameter of the transmitter coil. The coupler member is coupled to the part and configured to move with a movement of the part. The coupler member overlies at least a portion of the at least one receiver coil. The coupler member including a body, at least one projecting portion extending from the body and at least one magnet concentrically positioned with the body.

### CROSS REFERENCE TO RELATED APPLICATIONS

This utility patent application claims priority from U.S. Provisional Patent Application Ser. No. 63/445,486, filed on Feb. 14, 2023, the entire contents of which is incorporated herein in its entirety.

### TECHNICAL FIELD

The present disclosure relates to sensor assemblies, and, more specifically to inductive sensing and Hall Effect sensing assembly.

### BACKGROUND

Conventional rotary inductive sensing coil interferes with conductors placed over the sensing coil. Therefore, it is not feasible to establish low impedance connection through the coil in circumstances such as placing another electronic sensor at the center of the coil. Using arc-linear sensing coil, offsetting the inductive sensing target from the pivot, allows placement of a secondary sensor at the pivot of the target object without electrical connections thereof and sensing coil interfering with each other. However, an unintended lateral offset of the target pivot results in sensed angle error since it effectively results overall change in conductor target shift comparable to angle change. Further, because of the interference between sensing coil and conductor placement, conventional rotary sensing coils inhibit use of concentric secondary electronic sensor within one circuit board despite it being a desired inexpensive option.

### SUMMARY

In one embodiment, a position sensor assembly is provided. The position sensor assembly includes an inductive sensor assembly, a secondary sensor, and a coupler member. The inductive sensor assembly includes a transmitter coil that has an inner diameter and at least one receiver coil located proximate to the transmitter coil. The secondary sensor is positioned within the inner diameter of the transmitter coil. The coupler member is coupled to the part and configured to move with a movement of the part. The coupler member overlies at least a portion of the at least one receiver coil. The coupler member includes a body that has an area defined by an outer edge, at least two projecting protrusions extending beyond the outer edge and at least one target positioned within the area of the body. The at least one receiver coil is configured to generate a receiver signal when the transmitter coil is excited due to a change in an inductive coupling between the transmitter coil and the at least one receiver coil caused by the movement of the at least two projecting protrusions, the receiver signal being sensitive to a position of the part.

In another embodiment, a sensor assembly that has a multi-layered circuit board is provided. The sensor assembly includes an inductive sensor assembly, a secondary sensor, and a coupler member. The inductive sensor assembly includes a transmitter coil that has an inner diameter and a plurality of receiver coils located proximate to the transmitter coil. Each of the plurality of receiver coils having a pair of terminating ends that terminate spaced apart to define a gap therebetween in at least one layer of the multi-layered circuit board. The secondary sensor is positioned within the inner diameter of the transmitter coil. The secondary sensor has at least one electrically conductive trace extending therefrom and though the gap. The coupler member is configured to move. The coupler member overlies at least a portion of the plurality of receiver coils. The coupler member includes a body having an area defined by an outer edge, at least two projecting protrusions extending beyond the outer edge, and at least one target positioned within the area of the body. Movement of the coupler member modifies an inductive coupling between the transmitter coil and the plurality of receiver coils to generate a first receiver signal and the movement of the coupler member moves the at least one target detected by the secondary sensor to generate a second receiver signal, the second receiver signal indicative of a different change caused by movement of the coupler member than the first receiver signal.

In yet another embodiment, a position sensor assembly is provided. The position sensor assembly includes an inductive sensor assembly, a secondary sensor, and a coupler member. The coupler member is configured to move. The coupler member includes a body having an area defined by an outer edge, three projecting protrusions extending beyond the outer edge of the body, and at least one target positioned within the area of the body. The inductive sensor assembly includes a transmitter coil having an inner diameter and a plurality of receiver coils located proximate to the transmitter coil. Each of the plurality of receiver coils have a pair of terminating ends spaced apart to define a gap therebetween. Each of the plurality of receiver coils are arranged in a sinusoidal shape with five periods that spans 300 degrees. The plurality of receiver coils are separated into three independent inductive coil segments and two unused segments in which the plurality of receiver coils are configured to, in the three independent inductive coil segments, sense changes to the inductive coupling between the transmitter coil and the plurality of receiver coils caused by the three projecting protrusions passing through the respective three independent inductive coil segments. A secondary sensor positioned within the inner diameter of the transmitter coil, the secondary sensor having at least one electrically conductive trace extending therefrom and though the gap.

These and additional features provided by the embodiments described herein will be more fully understood in view of the following detailed description, in conjunction with the drawings.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 schematically depicts an environmental perspective view of a position sensor assembly and a part according to one or more embodiments herein;

FIG. 2 schematically depicts an isolated plan top view of the position sensor assembly of FIG. 1 according to one or more embodiments herein;

FIG. 3A schematically depicts a partial isolated plan top view of an inductive sensor assembly of the position sensor assembly of FIG. 1 according to one or more embodiments herein;

FIG. 3B schematically depicts a partial isolated plan top view of an inductive sensor assembly and a Hall Effect sensor assembly of the position sensor assembly of FIG. 1 according to one or more embodiments herein;

FIG. 3C schematically depicts a plan top view of a circuit board of the position sensor assembly of FIG. 1 according to one or more embodiments herein;

FIG. 4A schematically depicts an isolated plan top view of a transmitter coil and a plurality of receiver coils of the inductive sensor assembly of the position sensor assembly of FIG. 1 according to one or more embodiments herein;

FIG. 4B schematically depicts a cross section view of the transmitter coil and the plurality of receiver coils of the inductive sensor assembly of the position sensor assembly of FIG. 4A taken from lines 4B-4B according to one or more embodiments herein;

FIG. 5A schematically depicts an isolated plan top view of a first aspect coupler member of the position sensor assembly of FIG. 1 according to one or more embodiments herein;

FIG. 5B schematically depicts an isolated plan top view of a second aspect coupler member of the position sensor assembly of FIG. 1 according to one or more embodiments herein;

FIG. 5C schematically depicts an isolated plan top view of a third aspect coupler member of the position sensor assembly of FIG. 1 according to one or more embodiments herein;

FIG. 6A graphically depicts an example simulation of an XYZ offset performance of the inductive sensor assembly of the position sensor assembly of FIG. 1 according to one or more embodiments herein;

FIG. 6B graphically depicts an example simulation of an X, Y, Z offset from nominal position and measured a shift in an output of the inductive sensor assembly of the position sensor assembly of FIG. 1 according to one or more embodiments herein;

FIG. 7A schematically depicts an isolated plan top view of a first receiver coil of the plurality of receiver coils of the position sensor assembly of FIG. 1 according to one or more embodiments herein;

FIG. 7B schematically depicts an isolated plan top view of a second receiver coil of the plurality of receiver coils of the position sensor assembly of FIG. 1 according to one or more embodiments herein;

FIG. 7C schematically depicts an isolated plan top view of a third receiver coil of the plurality of receiver coils of the position sensor assembly of FIG. 1 according to one or more embodiments herein;

FIG. 7D schematically depicts an isolated plan top view of a fourth receiver coil of the plurality of receiver coils of the position sensor assembly of FIG. 1 according to one or more embodiments herein;

FIG. 7E schematically depicts an isolated plan top view of a fifth receiver coil of the plurality of receiver coils of the position sensor assembly of FIG. 1 according to one or more embodiments herein;

FIG. 7F schematically depicts an isolated plan top view of a sixth receiver coil of the plurality of receiver coils of the position sensor assembly of FIG. 1 according to one or more embodiments herein; and

FIG. 8 schematically depicts an isolated plan top view of three independent arc linear sections of coils, two unused segments, and a gap of the plurality of receiver coils of the position sensor assembly of FIG. 1 according to one or more embodiments herein.

### DETAILED DESCRIPTION

Embodiments presented herein are directed to a position sensor assembly that includes a radial multi-pole arc-linear inductive sensing assembly. The position sensor described herein includes redundant sensing utilizing both inductive sensing techniques and a secondary sensing technique, such as Hall Effect sensing techniques, with a single circuit board, such as a four-layer circuit board. Further, the position sensor described herein combines arc-linear sensing techniques and multi-pole rotary sensing techniques to overcome disadvantages of conventional sensor assemblies. For example, conventional sensor assemblies cannot include both Hall Effect and inductive sensing on the same board in close proximity because the metal and magnet for the Hall Effect sensing interfere with the inductive sensing. One solution is offsetting the sensing techniques with offset pivot axes and using mechanical devices such as links, gears, levers, and the like, to space apart of separate the two sensing techniques. Such solutions introduce slack, misalignment, mechanical failure, and the like.

A solution to these undesirable conditions described above may be arc-linear sensing with a concentric pivot axis. However, arc linear sensing is known to be less accurate compared to rotary sensing. Further, in arc linear sensor assemblies, an XY-offset causes output errors such as when a coupler is offset. When the coupler offsets, arc-linear coil confuses this with rotation. This result in deviation of signals from the sensing coils that is difficult to distinguish from a target rotated to achieve similar change in coverage. However, in another example for conventional sensor assembly, in a multi-pole rotary coil sensor assemblies, a coupler XY-offset is cancelled out. That is, conventional sensor assemblies with multiple poles within a rotary sensing coil incur a sensed angle error due to lateral shift in pivot can be avoided since lateral offset in one pole effectively results in counteracting lateral offset in the other poles. However, these multiple poles sensing application require the offsetting of the sensing techniques with offset pivot axes and using mechanical devices, as discussed above.

The position sensor assembly described herein includes a sensor arrangement that permits concentric secondary electronic sensor(s) and reduced susceptibility to sensed angle error caused by lateral pivot shift. For example, the position sensor described herein places multiple arc-linear inductive sensing coils radially, concentrically, and symmetrically and connecting the receiver coils in series. Such an arrangement creates an opening or gap between the sensing coils within a circuit board where the electrical connection to the concentric secondary electronic sensor can be placed without causing interference with the components for the Hall Effect sensing. Further, the lateral pivot shift in one direction results in counteracting signal changes in the coils, which can negate each other due to the series connection. Accordingly, the arrangement of the position sensor assembly described herein is advantageous compared to conventional sensor assemblies.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

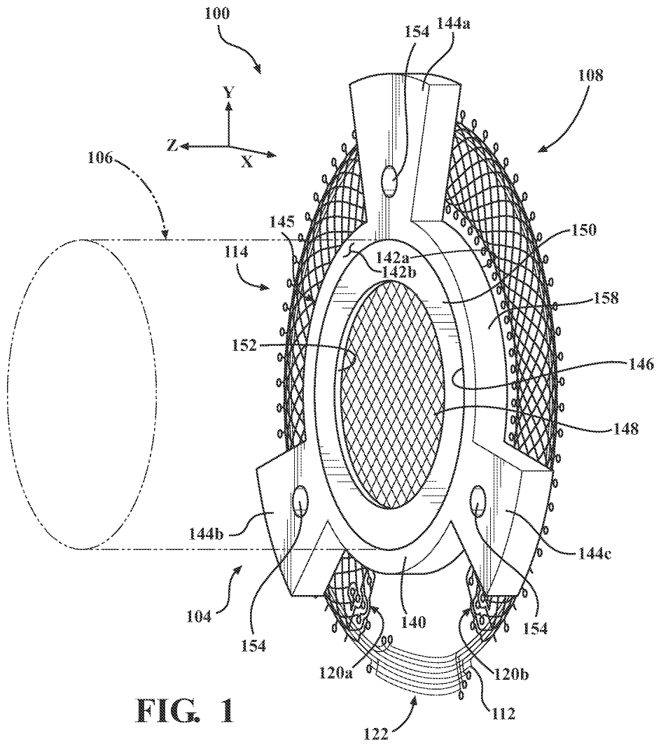

As used herein, the term “longitudinal direction” refers to the forward-rearward direction of the assembly (i.e., in the +/−X direction depicted in FIG. 1). The term “lateral direction” refers to the cross-direction (i.e., in the +/−Y direction depicted in FIG. 1), and is transverse to the longitudinal direction. The term “vertical direction” refers to the upward-downward direction of the assembly (i.e., in the +/−Z-direction depicted in FIG. 1).

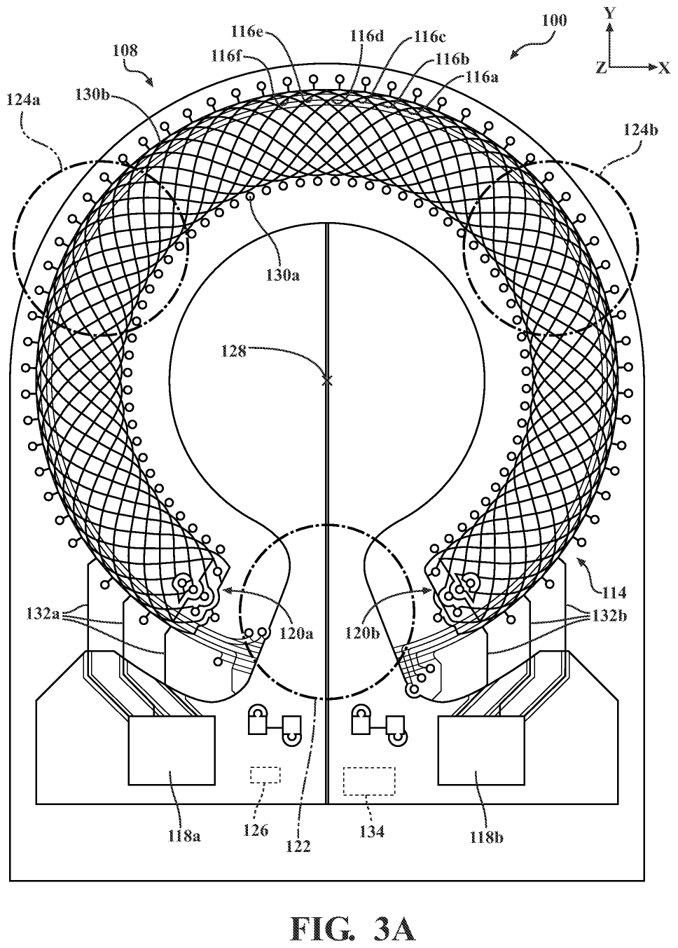

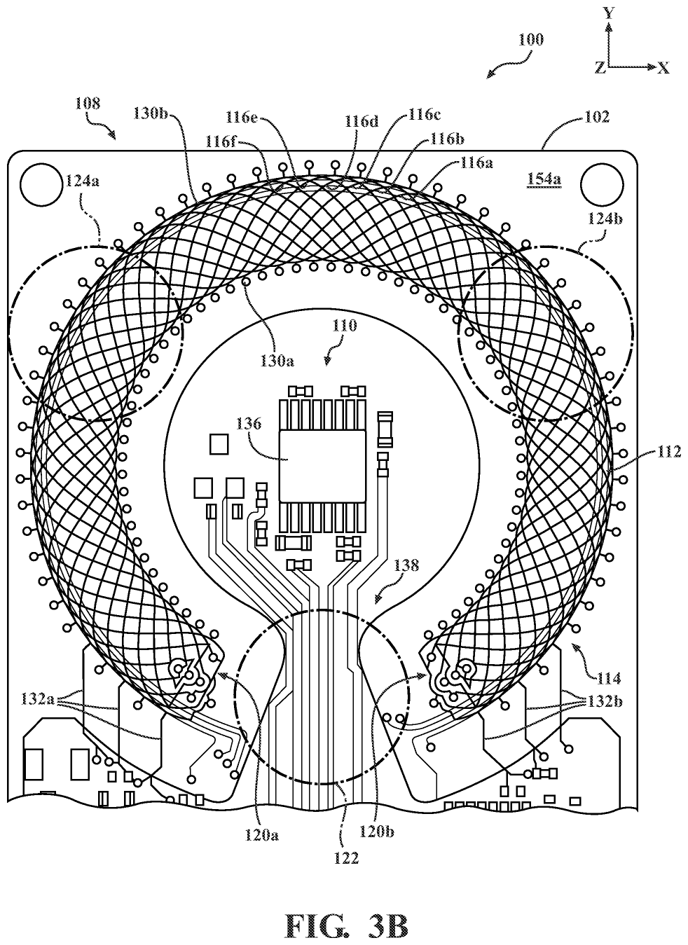

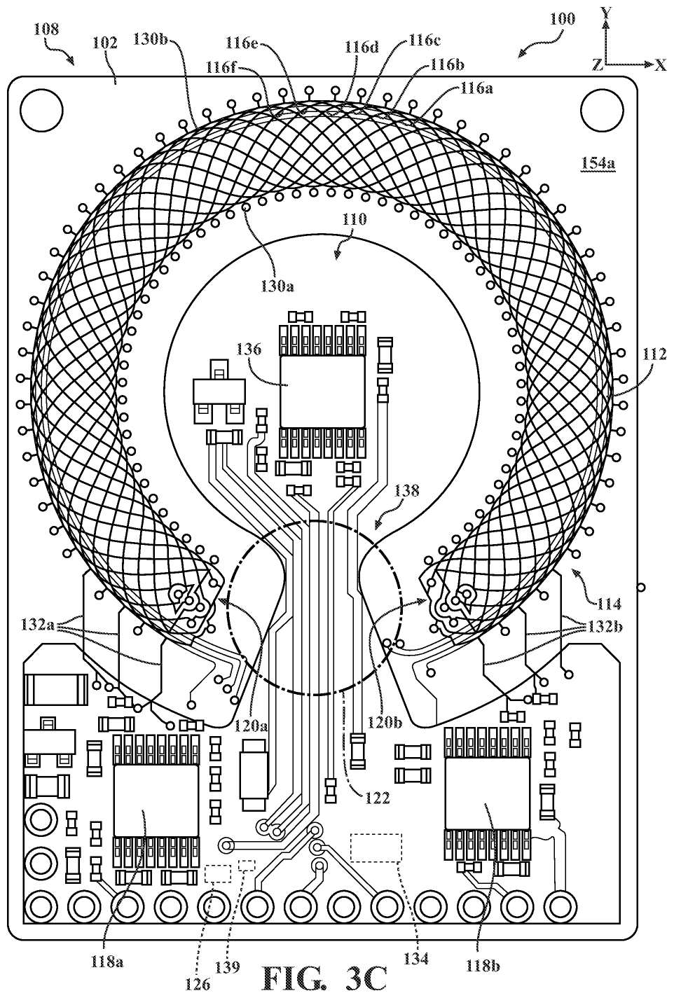

Now referring to FIGS. 1-2 and 3C, a simplified example environmental arrangement of a position sensor assembly is schematically depicted in FIG. 1. The position sensor assembly 100 described herein includes a circuit board 102 (FIG. 3C), a coupler member 104 coupled or otherwise attached to a part 106, such as a shaft or other member that moves, an inductive sensor assembly 108 and a secondary sensor assembly 110 (FIG. 3C). The inductive sensor assembly 108 may include a transmitter coil 112 (e.g., the outer rings), at least one receiver coil, depicted as a plurality of receiver coils 114, and a pair of inductive sensing interface integrated circuits 118a, 118b (FIG. 3C). In the depicted embodiments, the plurality of receiver coils 114 are six receiver coils 116a, 116b, 116c, 116d, 116e, 116f are utilized. Each of the plurality of receiver coils 114 are generally in a sinusoidal shape using inductive coils. This is non-limiting, and they may be more or less than six receiver coils utilized in the inductive sensor assembly.

As discussed in greater detail herein, the coupler member 104 overlies at least a portion of the inductive sensor assembly 108 and a portion of the secondary sensor assembly 110. Further, rotation of the coupler member 104 modifies the inductive coupling between the transmitter coil 112 and the plurality of receiver coils 114. Each of the plurality of receiver coils 114 may be configured to produce no signal in the absence of the coupler member 104, due to self-cancellation of various induced potentials. As an example, in some embodiments, each of the plurality of receiver coils 114 (e.g., six receiver coils 116a, 116b, 116c, 116d, 116e, 116f) may each include first and second loop structures configured so as to tend to cancel each other's induced potential. Each loop structure may have circumferential segments at the outer diameter alternating with circumferential segments at the inner diameter, corresponding to an overlay and/or underlay of the two loop structures.

Now referring to FIGS. 1-4B and 7A-7F, the positioning of the coil arrangement of the inductive sensor assembly 108 will be described in more detail. In some embodiments, each of the plurality of receiver coils 114 are arc-linear. Each of the plurality of receiver coils 114 may be configured to span five complete periods along an arcuate path or shape. Such an arrangement maximizes the balance between positively and negatively ‘coupled areas’, as discussed in greater detail herein. In the depicted embodiment, each of the plurality of receiver coils 114 may span 300 degrees to form or define a generally “C” shape. Further, each of the plurality of receiver coils 114 include terminating ends 120a, 120b, respectively. The terminating ends 120a, 120b are spaced apart from one another to define a gap 122 that extends the last 60 degrees. As such, none of the plurality of receiver coils 114 extend in or through the gap 122 within the circuit board 102, as discussed in greater detail herein. Further, each of the plurality of receiver coils 114 are electrically connected in a series arrangement.

It should be understood that the spanning 300 degrees in a generally “C” shape is non-limiting and it should be understood that the gap 122 may be larger or smaller than 60 degrees. For example, the gap 122 may be 40 degrees, 25 degrees, 75 degrees, and the like, which may change the span of each of the plurality of receiver coils 114. As such, the span of each of the plurality of receiver coils 114 is not limited to 300 degrees and may be any degrees such that the sum of the gap 122 and the span of the plurality of receiver coils 114 is 360 degrees to create a general circular arrangement to detect or sense movement of the coupler member 104, as discussed in greater detail herein.

Each of the plurality of receiver coils 114 include an innermost portion 130a, and an outermost portion 130b. Further, in some embodiments, the outermost portion 130b of each of the plurality of receiver coils 114 may be equal to or extend beyond the size of the coupler member 104, as discussed in greater detail herein. Additionally, in some embodiments, the outermost portion 130b of each of the plurality of receiver coils 114 may be equal to the outer diameter OD1 of the transmitter coil 112. In other embodiments, the outermost portion 130b of each of the plurality of receiver coils 114 extend beyond the outer diameter OD1 of the transmitter coil 112.

Still referring to FIGS. 1-4B and now to FIG. 8, in the depicted embodiment, there are two unused segments 124a, 124b, or blind areas that are not used. It should be understood that for purposes of coil manufacturing, the plurality of receiver coils 114, may be continuous connected through the two unused segments 124a, 124b, but this is an unused area or blind area, as best depicted in FIG. 8. That is, each of the plurality of receiver coils 114 may be depicted as a single coil extending through the unused segments 124a, 124b, but may be separated or broken in the unused segments 124a, 124b separating or defining three independent arc linear sections of coils 162a, 162b, 162c, as best illustrated in FIG. 8, and as discussed in greater detail herein. Each of the unused segments 124a, 124b may amount to be one pole such that the plurality of receiver coils 114 is utilized as three-pole arc-linear coils (e.g., each of the independent arc linear sections of coils 162a, 162b, 162c are a pole for a three-pole receiver) for a three-pole sensor. Each of the independent arc linear sections of coils 162a, 162b, 162c include portions of the plurality of receiver coils 114 (e.g., some of the periods of the generally sinusoidal shape pass through each of the independent arc linear sections of coils 162a, 162b, 162c). Further, each of the independent arc linear sections of coils 162a, 162b, 162c may be symmetrical in shape (e.g., angularly symmetrical), a same distance from the axis 128 (e.g., center point that the axis 128 transverses), have the same span, and are symmetrically spaced apart or separated.

The unused segments 124a, 124b are depicted at the four and eight o'clock positons of the plurality of receiver coils 114 and the gap 122 is depicted at the 6 o'clock position. This is non-limiting and the gap 122 and/or the unused segments 124a, 124b may be at different areas of the plurality of receiver coils 114. The unused segments 124a, 124b permit various electrical connections to other components of the inductive sensor assembly 108.

That is, the blind areas, or unused segments 124a, 124b, and the gap 122 allow for the placement of electrical connections without placing undesired conductors within the plurality of receiver coils 114, which can interfere with the sensing of the inductive sensor assembly 108 and/or the secondary sensor assembly 110, such as by changing or otherwise manipulating various fields, such as magnetic and/or electric fields, in an undesirable manner. This is non-limiting and there may be more or less blind areas or unused segments. In some embodiments, the number of blind areas or unused segments may be to match the number of targets (e.g., projecting protrusions) of the coupler member 104 such as, four pole, five pole, six pole, two pole, and the like, as appreciated by those skilled in the art. Further, each of the three independent arc linear sections of coils 162a, 162b, 162c permit for the sensing angle error to be reduced or eliminated due to the shape and arrangement of each of the three independent arc linear sections of coils 162a, 162b, 162c. That is, the shape and arrangement of each of the three independent arc linear sections of coils 162a, 162b, 162c permit for the shift of the pivot (coupler member 104) to change while each of the three independent arc linear sections of coils 162a, 162b, 162c account for the shift by sensing or detecting the coverage changes of the pivot (e.g., coupler member 104), in which the arrangement partially cancels each other.

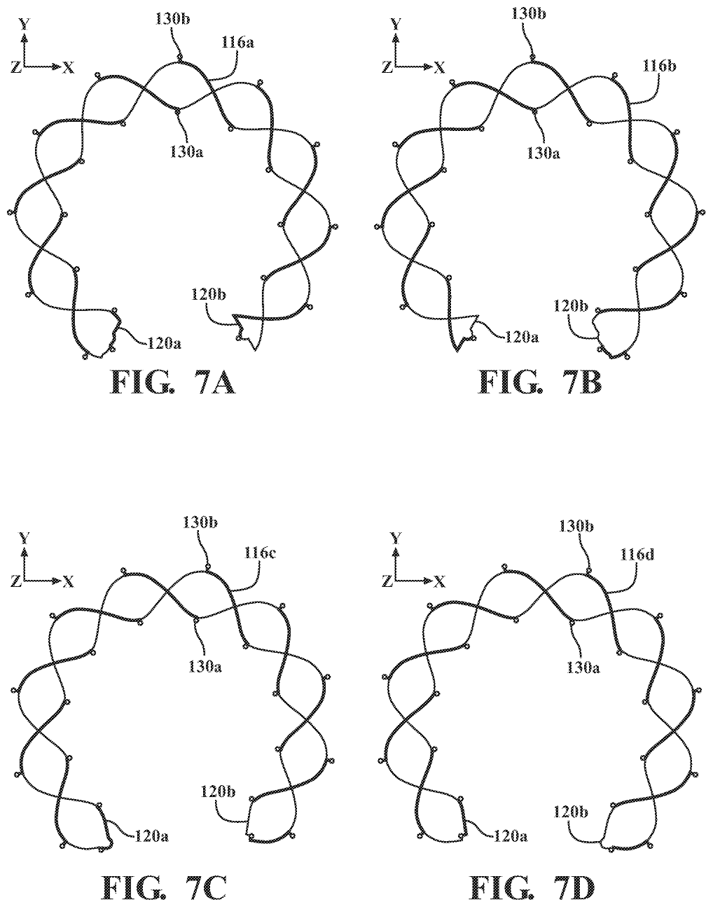

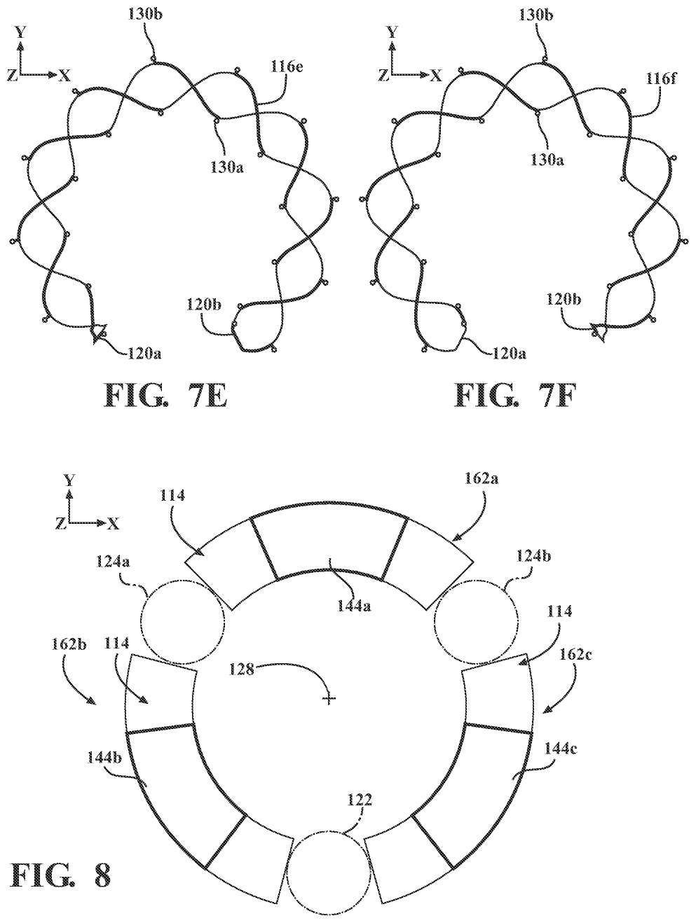

Now referring to FIGS. 7A-7F, schematically depicted is an example arrangement of the plurality of receiver coils 114. In the depicted embodiments, the plurality of receiver coils 114 may be generally in a continuous sinusoid shape. Such an arrangement and/or shape eliminates the demarcation between each of the plurality of receiver coils 114 and maximizes the balance between positively and negatively ‘coupled areas’. That is, each coil of the plurality of receiver coils 114 are arranged with alternating positive and negative loops such that various induced potentials of adjacent loops are cancelled or zero unless the coupler member 104 is introduced to modify the induced potentials. In the depicted embodiments, each of the plurality of receiver coils 114 span over 5 periods (e.g. 5 complete sinusoidal waves) with the span of 300 degrees. This is non-limiting, each span may be less than or more than five complete sinusoidal waves. As such, depending on the span, the number of periods (e.g. 5 sinusoidal waves) may change.

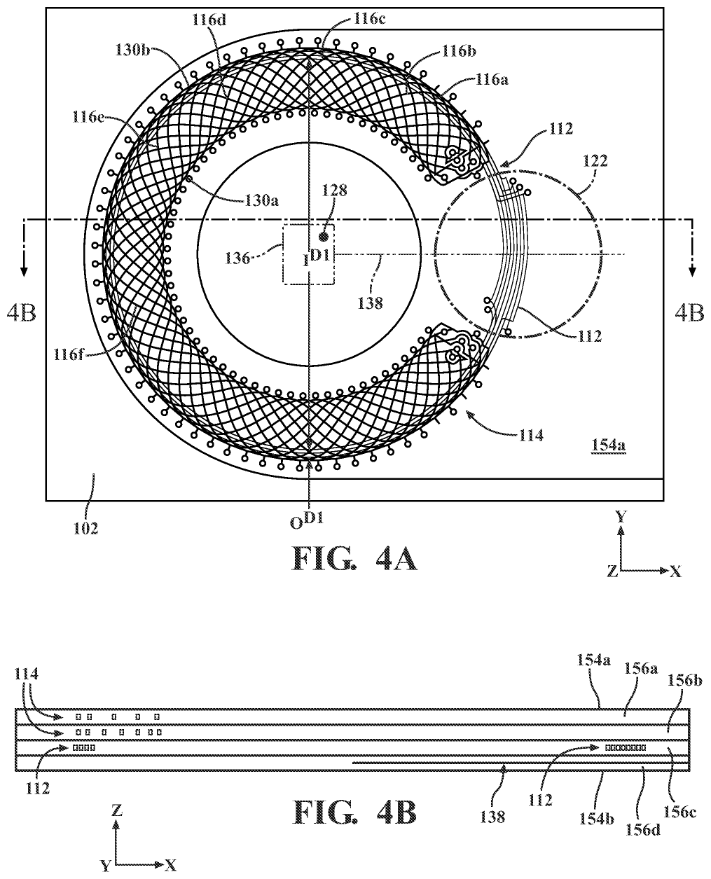

Now referring back to FIGS. 1-4B, the transmitter coil 112 may be generally circular and includes at least one circular loop formed substantially concentrically around an axis 128 of the inductive sensor assembly 108. In some embodiments, the transmitter coil 112 includes several loops formed substantially concentrically around the axis 128 and all windings or loops of the transmitter coil 112 may be oriented in the same rotational direction. The transmitter coil 112 may include an inner diameter ID1 and an outer diameter OD1 in a conventional circular coil design, as best depicted in FIG. 4A. This is non-limiting and other shapes and designs may be used.

The transmitter coil 112, which may also be referred to as an exciter coil, is excited by a source of alternating current 126 by an exciter signal. The exciting source or alternating current may be a high frequency alternating current source. Examples include, without limitation, a Colpitts oscillator, or other electronic oscillator. When excited by electrical energy, the transmitter coil 112 may radiate electromagnetic radiation. There is inductive coupling between the transmitter coil 112 and any other proximate coils, which induces a receiver signal in that coil (e.g., the plurality of receiver coils 114). That is, the transmitter coil 112 may be printed on or within the 102 circuit board so that, when energized by the high frequency alternating current source 126, the transmitter coil 112 generates a high frequency electromagnetic field. The outer diameter of the transmitter coil 112 may be positioned to be between the innermost portion 130a of each of the plurality of receiver coils 114 and the outermost portion 130b of each of the plurality of receiver coils 114.

Now referring to FIGS. 3A-3C and 4A-4B, the circuit board 102 may be a printed circuit board, single-sided, double-sided, multilayer, rigid, flexible, rigid-flexible, combinations thereof, and the like. In the depicted embodiment, the circuit board 102 includes an inner surface 154a and an outer surface 154b that is opposite to and spaced apart from the inner surface 154a to define a thickness. Further, in the depicted embodiment, the circuit board 102 has four layers 156a, 156b, 156c, 156d, as best depicted in FIG. 4B.

In the depicted embodiment, the transmitter coil 112 may be positioned on one layer of the circuit board 102. Each of the each of the plurality of receiver coils 114 may have portions that are positioned in separate layers (e.g., layers 156a, 156b in the depicted embodiment of FIG. 4B) of the circuit board 102 and/or alternate between layers in the axial direction or in the vertical direction (i.e., in the +/−Z-direction) such that a difference in the distance or airgap from the coupler member 104 is created, as discussed in greater detail herein. In some embodiments, portions of each of the each of the plurality of receiver coils 114 may be positioned in adjacent or adjoining layers. In other embodiments, portions of each of the plurality of receiver coils 114 may be positioned in layers that are spaced apart or separated by another layer that may be unoccupied or may contain other coils (i.e., a portion of the transmitter coil 112, components for the secondary sensor assembly 110, and the like).

As such, in some embodiments, portions of each of the plurality of receiver coils 114 overlap and underlap other portions of each of the plurality of receiver coils 114. It should be appreciated that the overlap portions are not connected with the path of the coil above and/or below, and that this coil arrangement permits sensing of the coupler member 104 from different distances or air gaps and permits for each of the plurality of receiver coils (e.g., the six receiver coils 116a, 116b, 116c, 116d, 116e, 116f depicted individually in FIGS. 7A-7F) to act as independent coils. In yet other embodiments, portions some or each of the each of the plurality of receiver coils 114 are disposed within the same layer of the circuit board 102 so to have the same depth in the vertical direction (i.e., in the +/−Z-direction) or airgap from the coupler member 104.

Further, as discussed in greater detail herein, the arrangement of the transmitter coil 112 and the plurality of receiver coils 114 permits for components of the secondary sensor assembly 110 (e.g. electrically conductive traces 138 and other electrical connections) to extend within any layer of the circuit board 102 with the exception, in some embodiments, of the layer occupied by the transmitter coil 112. In the depicted embodiment, the components of the secondary sensor assembly 110 (e.g., the electrically conductive traces 138 and other electrical connections) may extend through layers 156a, 156b, 156d and not have interference between components of the inductive sensor assembly 108 and components of the secondary sensor assembly 110. As such, the circuit board 102 may only include four layers.

Now referring back to FIGS. 3A-3C, the pair of inductive sensing interface integrated circuits 118a, 118b of the inductive sensor assembly 108 may be configured to utilize the RF frequency magnetic field. The pair of inductive sensing interface integrated circuits 118a, 118b may each be positioned to be coupled to the circuit board 102. In some embodiments, each of the pair of inductive sensing interface integrated circuits 118a, 118b may be positioned outside of, or beyond the outer diameter of the transmitter coil 112 and the outermost portions of each of the plurality of receiver coils 114. The inductive sensing interface integrated circuits 118a, 118b may be communicatively coupled to each of the plurality of receiver coils 114 via a plurality of traces 132a, 132b, respectfully. It should be understood that other conductive mediums may be used in addition to the plurality of traces 132a, 132b and/or instead of the plurality of traces 132a, 132b, as appreciated by those skilled in the art.

The pair of inductive sensing interface integrated circuits 118a, 118b may be communicatively coupled to a microcontroller 134. The microcontroller 134 may be an electronic control unit, a central processing unit (CPU), and the like, for performing the functions as described herein. As such, the microcontroller 134 may be configured to receive, analyze and process sensor data, perform calculations and mathematical functions, convert data, generate data, control system components, transmit data (e.g., to a vehicle side controller or electronic control unit), and the like. The microcontroller 134 may include one or more processors, and other components, for example one or more memory modules that stores logic that is executable by the one or more processors and a database based on, for example, received signal data from the inductive sensor assembly 108 and the secondary sensor assembly 110. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors.

The computer-executable instructions may include logic or algorithms, written in any programming language of any generation such as, for example machine language that may be directly executed by the processors, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents. Accordingly, the assemblies and/or systems described herein may be implemented in any conventional computer programming language, as preprogrammed hardware elements, or as a combination of hardware and software components.

The secondary sensor assembly 110 may include be magneto, optical, potentiometer, Hall Effect, and/or the like. For each of these, a secondary sensor 136 that corresponds to the type of the at least one target 148 may be used to sense or detect the at least one target 148 of the coupler member 104, as discussed in greater detail herein. The at least one target 148 may be multiple differing targets such that the secondary sensor assembly 110 includes a combination of sensors configured to sense or detect the corresponding at least one target 148. In a non-limiting example, the sensor assembly 110 may include sensors for detecting at least one target that changes a magnetic field (Hall Effect) and another target that changes optics (e.g., mirrors). As such, the secondary sensor assembly 110 may include more than one type of sensor that corresponds to the at least one target 148.

Further, the secondary sensor 136 is communicatively coupled to the microcontroller 134. In some embodiments, the secondary sensor 136 may be positioned anywhere within the inner diameter ID1 of the transmitter coil 112 and may be positioned inside of the innermost portion 130a of each of the plurality of receiver coils 114. In other embodiments, the secondary sensor 136 may be positioned to be concentric with the transmitter coil 112 and the plurality of receiver coils 114. The electrically conductive traces 138 or other electrical connections extend from the secondary sensor 136 through the gap 122 to other components of the position sensor assembly 100, such as, without limitation, to the microcontroller 134, a power source 139, and the like.

In a non-limiting example, in the depicted embodiments, the secondary sensor assembly 110 may utilize Hall Effect techniques to sense or detect the position of the at least one target 148. As such, the secondary sensor 136 may be a Hall Effect sensor 136. The Hall Effect sensor 136 is communicatively coupled to the microcontroller 134 and may be configured to utilize the DC frequency. The Hall Effect sensor 136 may be positioned on the circuit board 102 within the inner diameter of the transmitter coil 112 and inside of the innermost portion 130a of each of the plurality of receiver coils 114. In some embodiments, the Hall Effect sensor 136 may be positioned to be concentric with the transmitter coil 112 and the plurality of receiver coils 114. The Hall Effect sensor 136 may be utilized as a primary or a secondary, or redundant, sensor and may be configured to sense changes in the magnetic field intensity. The electrically conductive traces 138 or other electrical connections extend from the Hall Effect sensor 136 through the gap 122 to other components of the position sensor assembly 100, such as, without limitation, to the microcontroller 134, a power source 139, and the like.

It should be appreciated that the arrangement of the position sensor assembly 100 (e.g., the inductive sensor assembly 108) permits for the secondary sensor 136 of the secondary sensor assembly 110 to be positioned within the same circuit board and proximate to the transmitter coil 112 and the plurality of receiver coils 114.

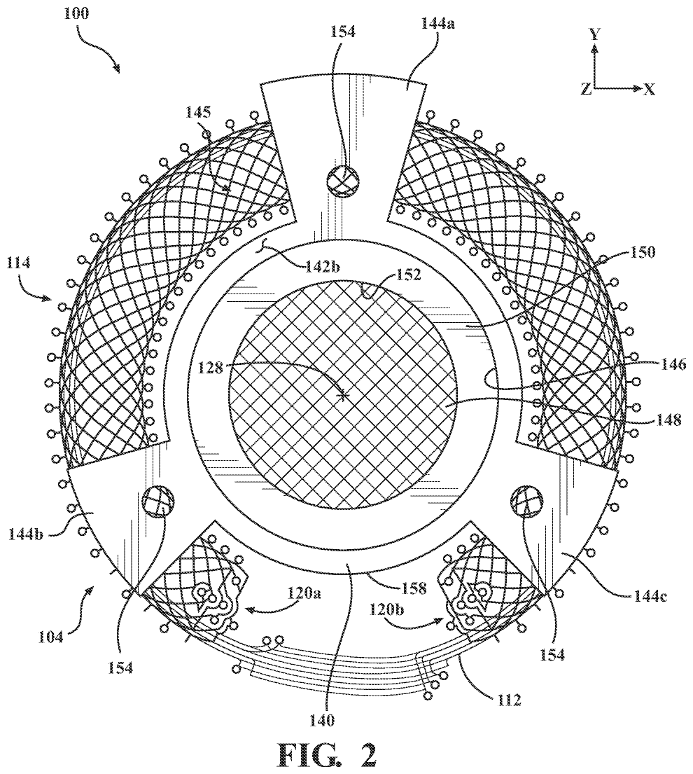

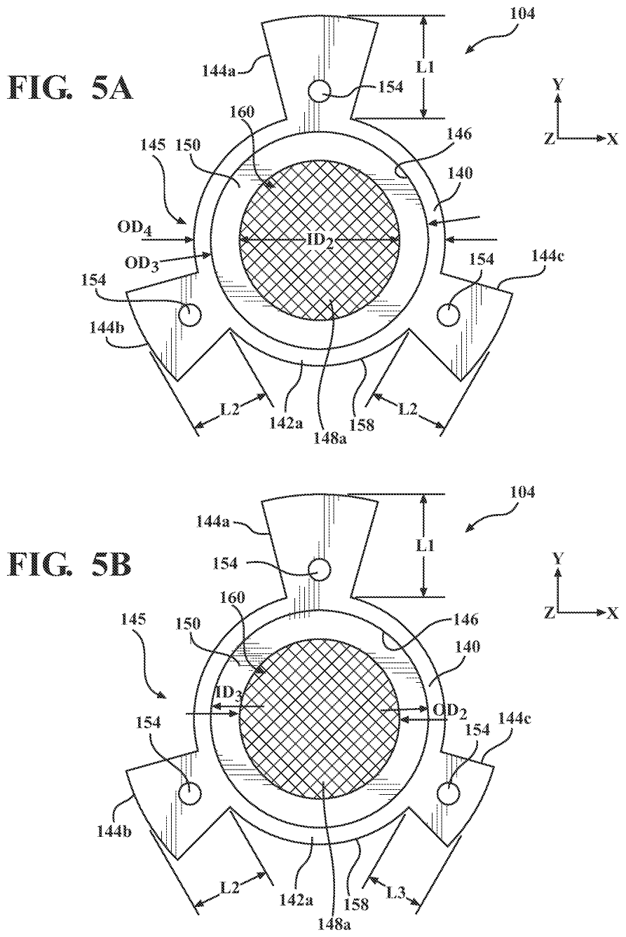

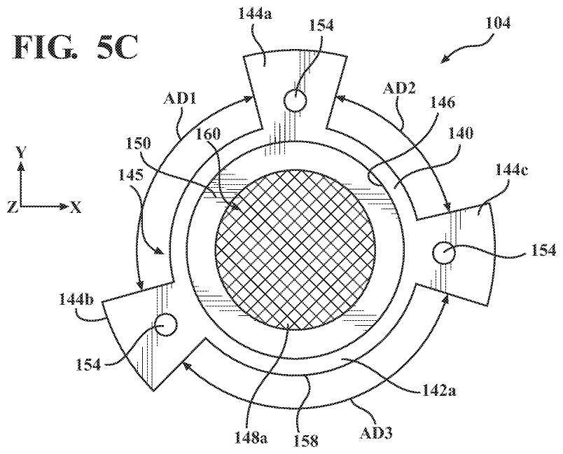

Now referring back to FIGS. 1-2 and to FIGS. 5A-5C, the coupler member 104 is coupled or otherwise attached to the part 106 such that when the part 106 moves (e.g., changing position), the coupler member 104 also moves. The coupler member 104 includes a body 140 that includes an exterior surface 142a and an interior surface 142b, which is opposite from and spaced apart from the exterior surface 142a to define a thickness. In some embodiments, the interior surface 142b may be coupled or otherwise attached to the part 106 via at least one fastener. The at least one fastener may include, without limitation, bolt and nut, screw, rivet, epoxy, weld, adhesive, hook and loop, and/or the like. In other embodiments, the part 106 may be received within a portion of the coupler member 104 such as in a snap-fit configuration to attach or otherwise couple the part 106 to the coupler member 104.

In the depicted embodiments, the coupler member 104 is a three-pole target. As such, in the depicted embodiment, three projecting protrusions 144a, 144b, 144c, or lobes, extend from an outer edge 158 of the body 140. That is the body 140 has an outer diameter OD4 defined by the outer edge 158. Each of the three projecting protrusions 144a, 144b, 144c, or lobes, extend outwardly from the outer edge 158 and beyond the outer diameter OD4 of the body 140. This is non-limiting and there may be less than or more than three projecting protrusions extending from the body 140. In some embodiments, there may be one or two projecting protrusions. In other embodiments, there may be five, six, eight, and many more projecting protrusions.

Further, in some embodiments, each of the projecting protrusions 144a, 144b, 144c may be integrally formed as a monolithic structure with the body 140 such that the body 140 and the projecting protrusions 144a, 144b, 144c are stamped together from the same piece of material to form a single piece without any coupling between the outer edge 158 and each of the projecting protrusions 144a, 144b, 144c. In other embodiments, some or all of the projecting protrusions 144a, 144b, 144c are coupled or otherwise attached to the outer edge 158 of the body 140 via fasteners such as, without limitation, a bolt and nut, a screw, a rivet, epoxy, weld, adhesive, hook and loop, and/or the like. Further, each of the projecting protrusions 144a, 144b, 144c are illustrated as a general frustum shape and are configured to act as a target for the inductive sensor assembly 108, as discussed in greater detail herein. This is non-limiting, and other shapes may be used, such as, without limitation, truncated pyramid, triangular, square, hexagonal, octagonal, parallelepiped, and/or the like. As such, any regular or irregular shape may be contemplated to include an edge that modifying the inductive coupling, as appreciated by those skilled in the art.

In some embodiments, each of the projecting protrusions 144a, 144b, 144c may be uniformly spaced apart so to have a rotational symmetric shape, as illustrated in FIGS. 5A and 5B. In some embodiments, each of the projecting protrusions 144a, 144b, 144c may not be uniformly spaced apart (e.g., non-uniform spacing), which creates or generates a non-symmetric rotational shape, as illustrated in FIG. 5C. In the non-symmetric rotational shape examples, the projecting protrusions 144a, 144b, 144c are not equally spaced apart such that there are differing angular distances (in degrees) between each of the projecting protrusions 144a, 144b, 144c, as illustrated in FIG. 5C. For example, the angular distance AD1 between the projecting protrusion 144a and projecting protrusion 144b is different from the angular distance AD2 extending between the projecting protrusion 144b and the projecting protrusion 144c (e.g., offset by a predetermined amount of degrees), resulting in a non-symmetric rotational shape. Further, in some embodiments, the angular distance AD3 extending between the projecting protrusion 144c and the projecting protrusion 144a may be also be different from the angular distance AD2 (e.g., offset by a predetermined amount of degrees), resulting in a non-symmetric rotational shape.

In some embodiments, at least one of the projecting protrusions 144a, 144b, 144c may extend radially from the body 140 (e.g., from the outer edge 158) a greater length compared to the other projecting protrusions 144a, 144b, 144c. For example, as best illustrated in FIG. 5A, the projecting protrusion 144a extends radially from the body 140 a length, illustrated by arrow L1, a greater distance or length than the other projecting protrusions 144b, 144c extend radially from the body 140 (e.g., from the outer edge 158) illustrated by arrow L2. As such, in this embodiment, the projecting protrusion 144a is longer or extends radially outward from the body 140 (e.g., from the outer edge 158) a greater distance compared to the projecting protrusions 144b, 144c resulting in a non-symmetric rotational shape. In other embodiments, any one of the projecting protrusions (e.g., 144b, 144c) may extend radially from the body 140 (e.g., from the outer edge 158) a greater distance or length than the other projecting protrusions (e.g. 144a, 144c) resulting in the non-symmetric rotational shape. As such, at least one of the projecting protrusions 144a, 144b, 144c may extend radially from the body 140 (e.g., from the outer edge 158) a different distance outwardly than the other projecting protrusions 144a, 144b, 144c.

In other embodiments, any two of the projecting protrusions 144a, 144b, 144c may extend radially from the body 140 (e.g., from the outer edge 158) a greater distance or length than the other projecting protrusion. Further, in some embodiments, all three of projecting protrusions 144a, 144b, 144c may extend radially from the body 140 (e.g., from the outer edge 158) at different distances or lengths resulting in a non-symmetric rotational shape, as best illustrated in FIG. 5B. In FIG. 5B, the length or distance of the projecting protrusion 144c, depicted by arrow L3, is less than the length or distance of the projection protrusion 144b, depicted by arrow L2, which in turn is less than the length or distance of the projection protrusion 144a, depicted by the arrow L1.

It should be appreciated that the shape of the coupler member 104 negates the gap 122 and the unused segments 124a, 124b of the plurality of receiver coils 114. As such, each of the projecting protrusions 144a, 144b, 144c may act as an individual target for the inductive sensor assembly 108 indicative of, and/or sensitive to the movement and/or positioning of the part 106. As such, movement of the projecting protrusions 144a, 144b, 144c may be sensed by the inductive sensor assembly 108 via detecting eddy currents changes in the three independent arc linear sections of coils 162a, 162b, 162c (FIG. 8) to generate a first receiver signal, which correlates to a position of the part 106, without the sensor errors described herein. That is, each edge of each of the projecting protrusions 144a, 144b, 144c may act as an individual target by changing an eddy current, which is detected by at least one of the plurality of receiver coils 114 in the three independent arc linear sections of coils 162a, 162b, 162c (FIG. 8) and is converted as an electronic or electromagnetic signal (e.g., the first receiver signal).

In some embodiments, the body 140 and/or the projecting protrusions 144a, 144b, 144c may be formed from a metallic material. For example, and without limitation, each of the projecting protrusions 144a, 144b, 144c and/or the body 140 may be formed from aluminum, copper, gold, silver, zinc, brass, steel, chrome, nickel, alloys, combination thereof, and/or the like. In other embodiments, the body 140, portions of the body 140, and the like, may also include, or in addition to the projecting protrusions 144a, 144b, 144c, may also be formed from different metallic materials described above.

This is non-limiting and the body 140 may be merely a second circuit board (e.g., separate and independent from the circuit board 102) or some other device, apparatus, assembly, or the like, that may not be molded or manufactured with the three projecting protrusions 144a, 144b, 144c, or lobes, and in which the three projecting protrusions 144a, 144b, 144c, or lobes, are coupled or otherwise attached therefrom and configured to extend therefrom. As such, in this embodiment, the three projecting protrusions 144a, 144b, 144c, may be coupled to the part 106 and/or to the second circuit board via fasteners such as, without limitation, a bolt and nut, a screw, a rivet, epoxy, weld, adhesive, hook and loop, and/or the like. As such, the outer edge 158 is not limited to edges of the metallic coupler, but may be outer edges to any device, apparatus, assembly, or the like, such that the outer edges of the second circuit board, a housing, and the like, in which the three projecting protrusions 144a, 144b, 144c, or lobes, may be coupled or otherwise attached and configured to extend therefrom. As such, the body 140 may be formed of any material, including conductive or non-conductive materials, and/or have portions of each, combinations of each, and/or the like.

In some embodiments, at least one of the projecting protrusions 144a, 144b, 144c may include at least one opening 154 configured as a mounting hole for the manufacturing processes such as a stamping hole.

In embodiments, the body 140 of the coupler member 104 may further include a an area 145 positioned within the outer edge 158 and in which a central portion 146 may be concentrically positioned in the area 145 of the body 140 to be concentrically positioned between each of the projecting protrusions 144a, 144b, 144c. In some embodiments, the central portion 146 are the area 145 may be synonymous and defined by the outer edge 158 and may include an inner diameter ID3 and an outer diameter OD4. In some embodiments, the body 140 may further include an annular portion 150 that is positioned to be concentric with the central portion 146 and/or the body 140. That is, the annular portion 150 is optionally based on the type of the at least one target 148. For instance, when the at least one target is magnetic, the annular portion 150 may be used. The annular portion 150 may have an outer diameter OD2, which may be less than the inner diameter ID3 of the central portion 146. As such, the annular portion 150 may be larger in diameter than the at least one target 148, but is smaller in diameter compared to the central portion 146 of the body 140.

The annular portion 150 may be made of a non-ferrous or non-conductive material. For example, and without limitation, the annular portion 150 may be formed from Acrylic or Polymethyl Methacrylate (PMMA), Polycarbonate (PC), Polyethylene (PE), Polypropylene (PP), Polyethylene Terephthalate (PETE or PET), Polyvinyl Chloride (PVC), Acrylonitrile-Butadiene-Styrene (ABS), and/or the like. As such, the annular portion 150 and the projecting protrusions 144a, 144b, 144c and/or the body 140 may be formed from different materials.

In some embodiments, the annular portion 150 may be molded with the body 140 of the coupler member 104 to form a monolithic structure. That is, in some embodiments, the annular portion 150 may be molded with the body 140 in a same manufacturing process such that the annular portion 150 is part of or formed with the body 140. In other embodiments, the annular portion 150 may be a member that is mounted or coupled to the body 140. That is, the annular portion 150 may be coupled, or otherwise attached, to the exterior surface 142a at or near the central portion 146 of the body 140 via at least one fastener. The at least one fastener may include, without limitation, bolt and nut, screw, rivet, epoxy, weld, adhesive, hook and loop, and/or the like.

In some embodiments, the annular portion 150 may include a recess 152. The recess 152 may be configured to receive at least one target 148. In some embodiments, the at least one target 148 may be received within the recess 152 in a snap-fit configuration. In other embodiments, the at least one target 148 may be mounted or coupled to the recess 152. That is, the at least one target 148 may be molded, coupled, or otherwise attached to the annular portion 150 at or near the central portion 146 of the body 140 via at least one fastener. The at least one fastener may include, without limitation, bolt and nut, screw, rivet, epoxy, weld, adhesive, hook and loop, and/or the like. As such, the recess 152 is configured to receive the at least one target 148 such that the annular portion 150 circumferentially surrounds the at least one target 148.

In other embodiments, the at least one target 148 may be mounted, coupled, or otherwise attached to the exterior surface 142a at or near the central portion 146 of the body 140 via at least one fastener. The at least one fastener may include, without limitation, bolt and nut, screw, rivet, epoxy, weld, adhesive, hook and loop, and/or the like. In this embodiment, the annular portion 150 be mounted or coupled to the exterior surface 142a at or near the central portion 146 of the body 140 via at least one fastener. The at least one fastener may include, without limitation, bolt and nut, screw, rivet, epoxy, weld, adhesive, hook and loop, and/or the like.

In other embodiments, the annular portion 150 may include an opening 160 that is configured to receive the at least one target 148. In some embodiments, the at least one target 148 may be received within the opening 160 in a snap-fit configuration. In other embodiments, the at least one target 148 may be mounted or coupled to the opening 160. That is, the at least one target 148 may be molded, coupled, or otherwise attached to the opening 160 of the annular portion 150 via at least one fastener. The at least one fastener may include, without limitation, bolt and nut, screw, rivet, epoxy, weld, adhesive, hook and loop, and/or the like. As such, the opening 160 is configured to receive the at least one target 148 such that the annular portion 150 circumferentially surrounds the at least one target 148.

It should be understood that in some embodiments, the annular portion 150, the at least one target 148, and the at least three projecting protrusions 144a, 144b, 144c may be formed from different materials.

The annular portion 150 may be configured as an insulator to provide a barrier between the magnetic force and/or magnet field and may direct the magnetic force and/or the magnet field perpendicular to the annular portion 150. In some embodiments, the at least one target 148 may generally be circular in shape with an outer diameter OD2 that is less than an inner diameter ID2 of the recess 152 or the opening 160. The annular portion 150 and the at least one target 148 may each be configured to move with the movement of the coupler member 104. In other embodiments, the at least one target 148 may be any shape or design such as, without limitation, square, triangular, octagonal, hexagonal, elliptical, irregular shaped, and/or the like. As such, in some embodiments, the recess 152 and the opening 160 of the annular portion 150 may have a corresponding shape to the at least one target 148.

The at least one target 148 may be configured to act or function a second target. That is, the movement of the at least one target 148 may be sensed by the components of the secondary sensor assembly 110 to determine the position of the coupler member 104, which ultimately is indicative of the part 106. The at least one target 148 may be a redundant sensing target and is utilized in the secondary sensor assembly 110.

In some embodiments, the movement of the at least one target 148 is sensed or otherwise detected by the secondary sensor assembly 110 configured to detect or sense various changes, outputs, and the like, that may be influenced by movement of the at least one target 148, such as changes in the magnetic field, optics, resistance, current, inductance, electric field, magnetic field, and/or the like, dependent on the type of the at least one target 148. As such, the detection or sensing of the various changes, outputs, and the like, may be used as the signal itself (e.g., to generate a second receiver signal to correlate to, and/or indicative of, a position of the part 106) or may be sensed data that the microcontroller 134 uses to correlate to a position of the part 106 to generate the second receiver signal. That is, the at least one target 148 of the coupler member 104 may be used for the detection of various changes or outputs (e.g., optics, resistance, current, inductance, electric field, magnetic field, and/or the like, depending on the type of the at least one target 148), to convert a displacement or angular measurement to an electronic or electromagnetic signal (e.g., the second receiver signal). Further, the secondary sensor assembly 110 may sense different changes or outputs (e.g., optics, resistance, current, inductance, electric field, magnetic field, and/or the like, depending on the type of the at least one target 148) than the sensed or detections by the inductive sensor assembly 108.

In some embodiments, the at least one target 148 is a magnet 148a, as best depicted in FIGS. 5A-5C. In this embodiment, the movement of the at least one magnet 148a and the sensing of the movement by the secondary sensor assembly 110 via detecting changes in the magnetic field to generate the second receiver signal, which correlates to the position of the part 106. That is, the at least one magnet 148a of the coupler member 104 may be used for the Hall Effect detection of magnetic change, to convert a displacement or angular measurement to an electronic or electromagnetic signal (e.g., the second receiver signal).

In operation, the part 106 may move, such as rotationally. In response, the coupler member 104 also moves with the part 106. The movement of the coupler member 104 changes or modifies the inductance or the electric field between the at least one of the plurality of receiver coils 114 and the transmitter coil 112. Further, because each of the plurality of receiver coils 114 are connected in series and the edges of the each of the projecting protrusions 144a, 144b, 144c change or modify the inductance or the electric field between the at least one of the plurality of receiver coils 114 and the transmitter coil 112, a lateral shift of pivot will result in each of the plurality of receiver coils 114 having coverage changes, which partially cancel each other such that a sensing angle error is reduced for lateral shift of pivot, as discussed in greater detail herein. Such a change or modification of eddy currents and/or the electric field may be determined, calculated, or otherwise received by the microcontroller 134 as the first receiver signal, which is correlated to, or may be indicative, of the current position of the coupler member 104. As such, the position of the part 106 may be known by knowing the position of the coupler member 104 with the sensing angle error is minimized with respect to the lateral shift of pivot of the part 106.

Additionally, movement of the coupler member 104 also moves the at least one target 148. Such a movement of the at least one target 148 may change the various measured outputs (e.g., optics, resistance, current, inductance, electric field, and/or the like, depending on the type of the at least one target 148), which may be detected or sensed by the secondary sensor assembly 110. Such a change or modification of the various outputs (e.g., optics, resistance, current, inductance, electric field, and/or the like, depending on the type of the at least one target 148) may be determined, calculated, or otherwise received by the microcontroller 134 as the second receiver signal, which is correlated to, or may be indicative, of the current position of the coupler member 104.

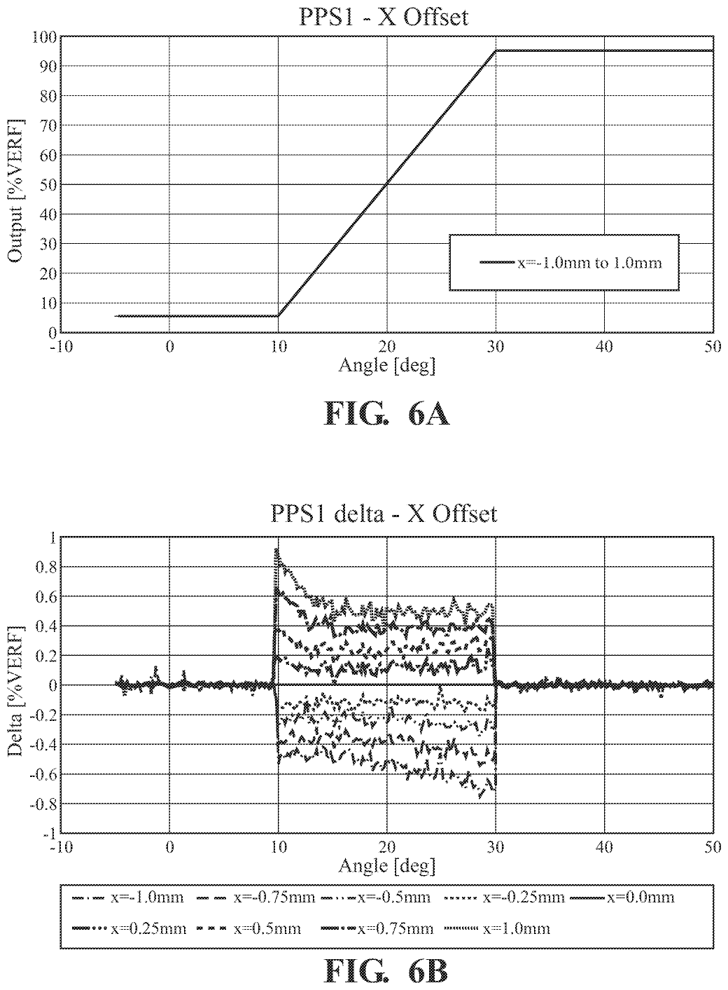

Now referring to back to FIG. 1 and to FIG. 6A, which graphically depicts an example simulation of an XYZ offset performance of the inductive sensor assembly 108 of the position sensor assembly 100. In the simulation, the sensor is programmed to output 5˜95% output within 20-degree span in terms of coupler member 104 rotation. As illustrated, at the various offsets in the X-direction (e.g., X=−1.0 mm to X=1.0 mm), the data is correlated with similar output and the same degrees. As such, the XYZ offset performance of the inductive sensor assembly 108 of the position sensor assembly 100 behaves as expected for the various offsets as illustrated.

Still referring to FIG. 1 and now to FIG. 6B, which graphically depicts an example simulation of an X, Y, Z offset from nominal position and measured a shift in an output of the inductive sensor assembly 108 of the position. As illustrated, the sensed angle error due to lateral shift in pivot is reduced to be similar or comparable to rotary inductive sensors

It should now be understood that the embodiments described herein are directed to a radial multi-pole arc-linear inductive sensing coil assembly, with multiple poles within a rotary sensing coil, configured to avoid a sensed angle error due to a lateral shift in pivot since the lateral offset in one pole effectively results in counteracting lateral offset in the other poles. As such, the present multi-pole inductive sensing coil assembly combines the advantages of arc-linear sensing coil and multi-pole rotary sensing coil.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A position sensor assembly comprising:
an inductive sensor assembly including:
a transmitter coil having an inner diameter; and
at least one receiver coil located proximate to the transmitter coil;
a secondary sensor positioned within the inner diameter of the transmitter coil; and
a coupler member coupled to a part and configured to move with a movement of the part, the coupler member overlies at least a portion of the at least one receiver coil, the coupler member including:
a body having an area defined by an outer edge;
at least two projecting protrusions extending beyond the outer edge of the body; and
at least one target positioned within the area of the body,
wherein the at least one receiver coil is configured to generate a receiver signal when the transmitter coil is excited due to a change in an inductive coupling between the transmitter coil and the at least one receiver coil caused by the movement of the at least two projecting protrusions, the receiver signal being sensitive to a position of the part.

2. The position sensor assembly of claim 1, wherein the movement of the coupler member moves the at least one target detected by the secondary sensor to generate a second receiver signal.

3. The position sensor assembly of claim 2, further comprising:
a circuit board having a plurality of layers,
wherein the at least one receiver coil has a pair of spaced apart terminating ends, the at least one receiver coil is a sinusoidal shape with five periods that spans 300 degrees between the pair of spaced apart terminating ends, the pair of spaced apart terminating ends define a gap within the plurality of layers of the circuit board.

4. The position sensor assembly of claim 3, wherein a plurality of traces for the secondary sensor pass through the gap defined by the pair of spaced apart terminating ends of the at least one receiver coil and the plurality of traces are positioned on a same layer of the plurality of layers of the circuit board.

5. The position sensor assembly of claim 3, wherein a plurality of traces for the secondary sensor pass through the gap defined by the pair of spaced apart terminating ends of the at least one receiver coil and the plurality of traces are positioned on different layers of the plurality of layers of the circuit board.

6. The position sensor assembly of claim 1, wherein:
the at least two projecting protrusions extending from the body of the coupler member is three projecting protrusions extending from the body;
the three projecting protrusions extending from the body are symmetrically spaced apart; and
at least one of the three projecting protrusions extending from the body extends a different distance outward from the body than the other two of the three projecting protrusions.

7. The position sensor assembly of claim 6, wherein the at least one receiver coil is separated into three independent inductive coil segments and two unused segments in which the at least one receiver coil is configured to, in the three independent inductive coil segments, sense changes to the inductive coupling between the transmitter coil and the at least one receiver coil caused by the three projecting protrusions passing through the respective three independent inductive coil segments.

8. The position sensor assembly of claim 7, wherein each of the three independent inductive coil segments are angularly symmetrical, have the same span, and are symmetrically spaced apart from one another.

9. The position sensor assembly of claim 1, wherein the secondary sensor is a Hall Effect sensor and the at least one target is at least one magnet.

10. The position sensor assembly of claim 9, wherein the body further includes an annular portion that circumferentially surrounds the at least one magnet, the annular portion is formed from a different material than the at least two projecting protrusions and the at least one magnet.

11. A sensor assembly having a multi-layered circuit board, the sensor assembly comprising:
an inductive sensor assembly including:
a transmitter coil having an inner diameter; and
a plurality of receiver coils located proximate to the transmitter coil, each of the plurality of receiver coils having a pair of terminating ends that terminate spaced apart to define a gap therebetween in at least one layer of the multi-layered circuit board;
a secondary sensor positioned within the inner diameter of the transmitter coil, the secondary sensor having at least one electrically conductive trace extending therefrom and though the gap; and
a coupler member configured to move, the coupler member overlies at least a portion of the plurality of receiver coils, the coupler member including:
a body having an area defined by an outer edge;
at least two projecting protrusions extending beyond the outer edge of the body; and
at least one target positioned within the area of the body,
wherein movement of the coupler member modifies an inductive coupling between the transmitter coil and the plurality of receiver coils to generate a first receiver signal and the movement of the coupler member moves the at least one target detected by the secondary sensor to generate a second receiver signal, the second receiver signal indicative of a different change caused by movement of the coupler member than the first receiver signal.

12. The sensor assembly of claim 11, wherein:
the plurality of receiver coils are separated into three independent inductive coil segments and two unused segments in which the plurality of receiver coils are configured to, in the three independent inductive coil segments, sense changes to the inductive coupling between the transmitter coil and the plurality of receiver coils caused by the at least two projecting protrusions passing through the respective three independent inductive coil segments.

13. The sensor assembly of claim 12, wherein each of the three independent inductive coil segments are angularly symmetrical, have the same span, and are symmetrically spaced apart from one another.

14. The sensor assembly of claim 11, wherein the secondary sensor is a Hall Effect sensor and the at least one target is at least one magnet.

15. The sensor assembly of claim 14, wherein the body further includes an annular portion that circumferentially surrounds the at least one magnet, the annular portion is formed from a different material than the at least two projecting protrusions and the at least one magnet.

16. The sensor assembly of claim 11, wherein the coupler member is coupled to a part that moves, the first receiver signal is correlated with a position of the part and the second receiver signal is correlated with the position of the part.

17. The sensor assembly of claim 11, wherein the first receiver signal and the second receiver signal are redundant signals.

18. The sensor assembly of claim 11, wherein:
the at least one electrically conductive trace for the secondary sensor passes through the gap defined by the pair of terminating ends of the plurality of receiver coils on a same layer of the multi-layered circuit board as at least a portion of the plurality of receiver coils; or
the at least one electrically conductive trace for the secondary sensor passes through the gap defined by the pair of terminating ends of the plurality of receiver coils and are positioned on different layer of the multi-layered circuit board than the transmitter coil.

19. The sensor assembly of claim 11, wherein the at least two projecting protrusions extending from the body are symmetrically spaced apart and at least one of the at least two projecting protrusions extending from the body extend a different distance from the body than the other projecting protrusion.

20. A position sensor assembly comprising:
a coupler member configured to move, the coupler member including:
a body having an area defined by an outer edge;
three projecting protrusions extending beyond the outer edge of the body; and
at least one target positioned within the area of the body;
an inductive sensor assembly including:
a transmitter coil having an inner diameter;
a plurality of receiver coils located proximate to the transmitter coil, each of the plurality of receiver coils having a pair of terminating ends spaced apart to define a gap therebetween, each of the plurality of receiver coils are arranged in a sinusoidal shape with five periods that spans 300 degrees, the plurality of receiver coils are separated into three independent inductive coil segments and two unused segments in which the plurality of receiver coils are configured to, in the three independent inductive coil segments, sense changes to the inductive coupling between the transmitter coil and the plurality of receiver coils caused by the three projecting protrusions passing through the respective three independent inductive coil segments; and
a secondary sensor positioned within the inner diameter of the transmitter coil, the secondary sensor having at least one electrically conductive trace extending therefrom and though the gap.
